(19) United States
(12) Patent Application Publication
(10) Pub. No.: US 2007/0098624 A1
(43) Pub. Date: May 3, 2007

(54) Andhydrous hydrogen fluoride composition and method of producing the same

(75) Inventors: Matthew Luly, Hamburg, NY (US); George Cook, Buffalo, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/260,804

(22) Filed: Oct. 27, 2005

(51) Int. Cl. C01B 7/19

(52) U.S. Cl. 423/483; 423/484

(57) ABSTRACT

A method of reducing the water content of anhydrous hydrogen fluoride wherein crude anhydrous hydrogen fluoride having a first concentration of water impurity is contacted with carbonyl fluoride to produce anhydrous hydrogen fluoride having a second concentration of water impurity, wherein the second concentration is lower than the first concentration.

### BACKGROUND OF THE INVENTION

(1) Field of Invention

The present invention relates to methods for preparing and purifying anhydrous hydrogen fluoride. In addition, the present invention relates to anhydrous compositions of hydrogen fluoride and carbonyl fluoride.

(2) Description of Related Art

Anhydrous hydrogen fluoride (AHF) is a highly acidic compound. As used herein, the terms “anhydrous hydrogen fluoride” and “AHF” are used to refer to hydrogen fluoride which is not present as a solute in an aqueous solution. Thus, the terms “anhydrous hydrogen fluoride” and “AHF” are intended to include hydrogen fluouride which includes relatively minor amounts of water.

One feature of AHF is that it can react with a wide variety of substances including alkalis, metals, oxides, silicates, etc. Hydrogen fluoride's reactive nature combined with its solubility with many organic and inorganic compounds and its unique properties related to pressure, temperature, and humidity, enable it to be used in numerous industrial processes including etching and cleaning of glass, semiconductor chips, and ceramics. It can also be used as a catalyst in paraffin alkylation, as a fluorinating agent, in the synthesis of fluorides, in the production of various inorganic, organic, and biological compounds, for separating uranium isotopes, for electroplating processes, as well as many other processes.

One method for producing hydrogen fluoride (HF) in commercial quantities is involves heating purified fluorspar (calcium fluoride) with concentrated sulfuric acid to produce a hydrogen fluoride gas, which may be condensed by cooling. Other production mentods for the production of HF are also available, such as by the conversion of flourosilicic acid. Commercially produced HF typically contains water impurities which can stem from several sources. For example, the fluorspar used to produce HF typically contains up to about 1% each of calcium carbonate and silica. These impurities can react with the sulfuric acid to produce water.

AHF is commercially available in various grades depending on the desired purity and moisture content. Typically, commercial AHF contains less than 200 ppm of water, although higher purity grades of AHF are available with moisture contents as low as 25 ppm.

However, many applications prefer, or even require, a source of AHF having a moisture content of 10 ppm or lower. For example, U.S. Pat. No. 5,073,232 (Ohmi) discloses a method of using an AHF vapor mixture to etch semiconductor films. According to Ohmi, the preferred moisture content of the AHF is not more than 10 vppm, and even more preferably, not more than several vppm. Other examples of applications requiring AHF with very low moisture levels include electrochemical storage devices, such as F₂ cells. As show in “Preparations, Properties, and Technology of Fluorine and Organic Fluoro Compounds”, the quality of AHF feed into an F₂ cell affects the purity of the gas evolved. (Charles Slesser, 1^{st} Ed., McGraw-Hill Book Co. (1951), p. 62) Water impurities in F₂ cells can give rise to the production of OF₂ and O₂ impurities in the fluorine gas, which are especially detrimental in semiconductor applications.

In general, it is very difficult to produce and store high purity AHF through conventional techniques. For example, water and hydrogen fluoride are miscible and form a constant boiling point mixture and are therefore difficult to separate by distillation. As used herein, the term “high purity AHF” refers generally to AHF having a relatively low moisture content. Various methods of producing high purity AHF have been proposed, but such prior methods have had at best limited success at reducing moisture content to the low levels that are desirable in many applications. U.S. Pat. No. 4,062,930 (Zawadzki), for example, describes a method of producing AHF from fluorosilicic acid. According to this process, AHF can be produced having a water content of 400 ppm. Other examples include U.S. Pat. No. 5,164,052 (Bulan) (describing a process for purifying AHF in which metallic and non-metallic impurities, such as boron, sulfur, phosphorous, arsenic, and silicon, are removed via electrolysis); U.S. Pat. No. 4,083,941 (Jayawant) (describing a process for removing arsenic and sulfite impurities from AHF by contacting AHF with hydrogen peroxide, followed by treatment methanol or sulfuric acid and distillation); U.S. Pat. No. 4,424,067 (Tarasenko) (describing the reduction of arsenic trifluoride content of AHF by diffusing the AHF through a non-porous thin fluoropolymer film); U.S. Pat. No. 1,960,347 (Osswald) (teaching a process wherein HF is passed through cold sulfuric acid to which sulfuric anhydride has been added to remove water).

Thus, there remains the need for an economical method of producing high purity AHF.

### SUMMARY OF INVENTION

According to one aspect of the present invention, applicants have discovered that the aforementioned problems, as well as others, can be solved by contacting an AHF composition with carbonyl fluoride in amounts and under conditions effective to reduce the concentration of water in the AHF composition, preferably contacting the carbonyl fluoride (COF₂) with the AHF to reactively reduce, and preferably eliminate, water present in the AHF composition. Without being bound to any particular theory, it is believed that the reaction between water and carbonyl fluoride generally proceeds as follows:
H₂O+COF₂→CO₂+2HF
The CO₂ by-product produced by this reaction can be easily separated from the hydrogen fluoride. Thus, the present invention not only substantially reduces the moisture content of a hydrogen fluoride composition, it also creates HF from the water impurities.

The hydrolysis reaction in which carbonyl fluoride reacts with water to produce carbon dioxide and hydrogen fluoride is known in the art. However, the art conventionally teaches that this reaction should be avoided because it produces toxic gas (i.e. hydrogen fluoride). Applicants have discovered a method for purifying anhydrous hydrogen fluoride by utilizing this hydrolysis reaction in a way that is contrary to conventional teachings.

According to one aspect of the present invention, methods of purifying AHF are provided wherein crude AHF having a first water impurity concentration is contacted with carbonyl fluoride to produce a purified AHF product having a second water impurity concentration that is lower than the first water impurity concentration.

Another aspect of the present invention provides methods of producing AHF by contacting aqueous HF with carbonyl fluoride. This method of converting aqueous HF into AHF cannot be readily accomplished via distillation techniques due to the azeotrope that forms between water and HF.

Yet another aspect of the present invention is an anhydrous composition comprising hydrogen fluoride and carbonyl fluoride. Packaging AHF with a small amount of carbonyl fluoride can substantially reduce or even more preferably eliminate moisture present in the AHF and help to maintain a low level of water in the AHF or to keep it essentially free of moisture subsequent to its packaging.

### DETAILED DESCRIPTION OF PREFERRED EMBODIMENTS OF THE INVENTION

The present invention relates to methods of reducing the water content of anhydrous hydrogen fluoride, methods of producing anhydrous hydrogen fluoride, and substantially anhydrous compositions comprising hydrogen fluoride and carbonyl fluoride. Applicants have discovered that the addition of carbonyl fluoride to a composition comprising hydrogen fluoride and water can effectively reduce the concentration of water in that composition. Although not wishing to be bound by any particular theory, Applicants believe that this reduction in moisture is accomplished via a hydrolysis reaction wherein water reacts with carbonyl fluoride to produce carbon dioxide and hydrogen fluoride according to the following reaction scheme:

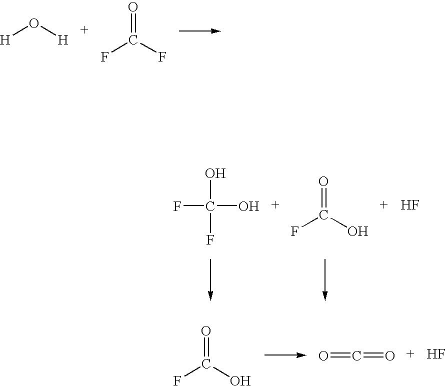

As this reaction scheme shows, the net reaction is H₂O+COF₂→CO₂+2HF. Thus, the reaction eliminates water while producing hydrogen fluoride and carbon dioxide, the latter of which can be easily separated from hydrogen fluoride. Carbonyl fluoride eliminates a stoichiometric amount of water and is capable of producing anhydrous hydrogen fluoride with very little, if any, moisture.

The extent of the water elimination according to the present invention depends upon various factors, including but not necessarily limted to the following three factors: (1) the quantity of carbonyl fluoride that is brought into contact with the water; (2) the duration of the contact time; and (3) the reaction kinetics. These factors are interrelated to the extent that they effect the reduction of moisture. For example, a decrease in the quantity of carbonyl fluoride can be offset by an increase in the contact time to arrive at the same level of water elimination. Each of these factors will be discussed in more detail below.

Preferred embodiments of the methods for purifying anhydrous hydrogen fluoride according to the present invention include the steps of (a) providing crude AHF having a first concentration of water impurity; and (b) contacting the crude AHF with carbonyl fluoride to produce an AHF product having a second concentration of water impurity that is lower than the first concentration of water impurity. Although the purification methods described herein are generally applicable to crude AHF of any quality, in certain preferred embodiments, the crude AHF comprises at least 97 wt. % hydrogen fluoride and a first concentration of water not more than 1 wt. %. In other preferred embodiments, the purified anhydrous hydrogen fluoride will have a moisture content not greater than about 0.01 wt. %, 200 ppm, 25 ppm, 10 ppm, or 1 ppm depending upon the desired purity of AHF. In still other preferred embodiments, the AHF product will be essentially free of moisture.

As described above, water is preferably stoichiometrically eliminated via a reaction with carbonyl fluoride. Thus, the amount of water eliminated is directly dependent in certain embodiments upon the amount of carbonyl fluoride available to react with the water. The quality of AHF product desired, in particular the moisture content of that product, may be controlled, in part, by controlling the quantity of carbonyl fluoride brought into contact with the crude AHF and the duration of that contact. In certain embodiments, the amount of carbonyl fluoride contacted with water impurities is at a mole ratio of 1:1. Given sufficient time, it is theoretically possible to eliminate all of the water impurities using this ratio of reactants since 1 mole of carbonyl fluoride reacts with and thereby eliminates 1 mole of water. Considering the relatively low concentrations of water in the crude AHF, preferred embodiments of the present invention utilize a molar ratio of carbonyl fluoride to water greater than 1:1 to increase the probability that carbonyl fluoride molecules will come into contact with water molecules, and thereby eliminating the water. However, the present invention is not limited to such embodiments and may be practiced with molar ratios of carbonyl fluoride to water less than 1:1. In general, as the concentration of water impurities decrease, the ratio of carbonyl fluoride to water is preferably increased to achieve a certain level of water elimination at a certain contact time. In certain preferred embodiments, the molar ratio of carbonyl fluoride to water is from about 1:1 to about 10:1, although an even higher ratio may be used depending on the desired purity, contact time, and reaction kinetics. Based on the teachings contained herein, it is believed that those skilled in the art will be able to determine adequate values for each of these process parameters without undue experimentation.

With respect to contact time, it contemplated that generally an increase in the contact time or the reaction rate will generally increase the degree of water removal. Since physical contact between the carbonyl fluoride and the water in the AHF is necessary in order for the reaction to proceed, adequate mixing of the carbonyl fluoride and the water molecules contained in the AHF is preferred. Although it is believed that the particular contact time may vary widely based on the specific application, it is preferred in certain embodiments that the contact time if from about 1 second to about 100,000 seconds, more preferably from about 5 seconds to about 5,000 seconds, and even more preferably from about 10 seconds to about 1,000 seconds. Longer or shorter contact times are of course also possible within the scope of the present invention. In general, long contact times utilize carbonyl fluoride more effectively, but make the process slower. The particular contact time for each particular embodiment of the present invention will generally depend upon economic and other factors, and in generally those skilled in the art should be able to readily determine the contact time to use in any particular application without undue experimentation. For example, crude AHF may be continuously purified according to the present invention wherein a large excess of carbonyl fluoride is utilized. In such embodiments, the contact time may be very short. In other embodiments, crude AHF may be batch purified using a molar ratio of carbonyl fluoride to water of about 1:1, wherein that the process is allowed to continue for days or even weeks, such as for example, in AHF held in storage tanks or packaged in small cylinders.

With respect to reaction kinetics, such as hydrolysis reaction rate, reaction temperature, and the like, it is contemplated that the present methods can be conducted at any practical temperature and pressure. One skilled in the art would be able to determine adequate values for each of these process parameters based upon the present disclosure without undue experimentation.

In certain preferred embodiments, the AHF product will have a ratio of first molar concentration of water to second molar concentration of water of at least about 2:1, more preferably at least about 1000:1, and even more preferably at least at least about 1,000,000:1. To convert aqueous hydrogen fluoride to anhydrous hydrogen fluoride according to the methods of the present invention, an even higher ratio may be required. To produce purified anhydrous hydrogen fluoride having the least amount of water, a stoichiometric excess of carbonyl fluoride to water should be utilized, provided that small amounts of carbonyl fluoride in the product are tolerable.

According to certain embodiments of the invention, the carbonyl fluoride is contacted with water in the AHF while both the carbonyl fluoride and AHF are in the gas phase. In other embodiments, carbonyl fluoride in the gas phase is contacted with liquid AHF via a sparging process. In still other embodiments, carbonyl fluoride in the liquid phase can be mixed with AHF in the liquid phase. Considering the fact that, at ambient pressure, the boiling point of carbonyl fluoride is lower than the freezing point of hydrogen fluoride, the mixing of liquid hydrogen fluoride and liquid carbonyl fluoride generally must conducted at a pressure greater than 1 atm.

In certain embodiments, the purification method according to the present invention is preformed via a batch process. In other embodiments, the method is performed via a continuous process. In general, any process system and equipment may be used to conduct the contacting step provided that the equipment is made from suitable materials of construction and provides for adequate mixing and physical contact between the carbonyl fluoride and the moisture in the AHF. Those skilled in the art should be able to determine the appropriate systems and equipment for conducting the methods according to the present invention according to the particular application.

With respect to methods for producing anhydrous hydrogen fluoride, preferred embodiments comprise the steps of (a) providing aqueous hydrogen fluoride; and (b) contacting the aqueous hydrogen fluoride with carbonyl fluoride to produce anhydrous hydrogen fluoride. As used herein, the term aqueous hydrogen fluoride means a mixture of water and hydrogen fluoride wherein the mixture comprises at least 3 wt. % water. As known in the art, the terms aqueous hydrogen fluoride and hydrofluoric acid or solutions of hydrofluoric acid can be used interchangeably. Aqueous hydrofluoric acid is commercially available at concentrations including, but not limited to, 38%, 47%, 53%, and 70%.

The anhydrous hydrogen fluoride produced by this method will have a water concentration less than the concentration of water in the aqueous hydrogen fluoride starting material. In certain preferred embodiments, the anhydrous hydrogen fluoride produced by this method will have a water concentration of less than about 3 wt. % based upon the total weight of the composition.

Another aspect of the invention provides compositions comprising anhydrous hydrogen fluoride and carbonyl fluoride. The presence of carbonyl fluoride in the AHF provides for a means of reducing or essentially eliminating moisture that is in the composition, or that might enter into the composition after it has been packaged as a high purity AHF product. In certain preferred embodiments, the compositions comprises at least about 97 wt. % hydrogen fluoride and not more than about 1 wt. % of carbonyl fluoride. In certain other preferred embodiments, the composition is essentially free of moisture. As used herein, the phrase “essentially free of moisture” means that the composition comprises less than about 0.1 ppm of water.

### EXAMPLES

Additional features of the present invention are provided in the following prophetic examples, which should not be construed as limiting the claims in any way.

### Example 1

A 1 liter stainless steel cylinder is evacuated and then charged with about 500 grams of AHF having 1 wt. % of water. The cylinder is chilled with liquid nitrogen and then about 40 grams of COF₂ is added to the cylinder. After closing the cylinder's valve, the cylinder is removed from the liquid nitrogen and allowed to warm under ambient conditions for 12 hours. The water concentration within the cylinder is measure with a conductivity probe and is found to be less than 100 ppm.

### Example 2

A 1 liter stainless steel cylinder is evacuated and charged with about 500 grams of AHF having a water concentration of 100 ppm. The cylinder is chilled with liquid nitrogen and then about 5 grams of COF₂ is added to the cylinder. After closing the cylinder's valve, the cylinder is removed from the liquid nitrogen and allowed to warm under ambient conditions for 12 hours. The water concentration within the cylinder is measure with a conductivity probe and is found to be undetectable.

### Example 3

The procedure in Example 2 was repeated, but the final water concentration within the cylinder is measured by Fourier Transform Infrared Spectroscopy (FTIR) and is found to be less than 1 ppm.

### Example 4

The procedure in Example 2 was repeated, but the cylinder is warmed to 50° C. The water concentration and is found to be undetectable.

### Example 5

A 1 liter stainless steel cylinder is fitted with an inlet, a dipleg, and a outlet. The cylinder is charged with about 500 grams of AHF having 500 ppm of water. The cylinder is chilled to reduce the vapor pressure. One gram of COF₂ is added to the cylinder via the dipleg at a rate of 50 sccm and is allowed to bubble through the liquid AHF. Gas accumulating at the top of the cylinder is allowed to escape through the outlet. The gas flowing through the outlet was sent to a trap at dry ice temperature. The liquid AHF in the cylinder is analyzed and found to have less than 1 ppm water. A small amount of AHF is carried to the second trap, where it is analyzed and found to have a non-detectable water content.

### Example 6

The apparatus in Example 5 is fitted with a condenser at the exit to condense and return HF while allowing COF₂ and CO₂ to escape the cylinder. The experiment is not run chilled, but at ambient temperature. The liquid AHF in the cylinder is analyzed and found to have less than 1 ppm water.

### Example 7

A 2 liter PTFE flask is fitted with a 1 inch diameter by 2 foot long column packed with Raschig rings. 1 liter of HF containing 200 ppm water is placed in the flask and continuously circulates to the top of the column where it is allowed to drain back to the flask. The top of the column is fitted with a condenser to prevent the escape of HF. A flow 20 sccm of COF₂ is introduced at the bottom of the column and the gas flowing through the column and condenser is sent to a scrubber. At the end of one hour, the AHF is analyzed and found to contain <1 ppm water.

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method of reducing the water content of an anhydrous hydrogen fluoride composition comprising the steps of:
(a) providing crude anhydrous hydrogen fluoride having a first concentration of water; and
(b) contacting said crude anhydrous hydrogen fluoride with carbonyl fluoride to produce anhydrous hydrogen fluoride having a second concentration of water, wherein said second concentration is lower than said first concentration.

2. The method of claim 1 wherein said second concentration of water is not greater than about 200 ppm.

3. The method of claim 2 wherein said second concentration of water is not greater than about 25 ppm.

4. The method of claim 3 wherein said second concentration of water is not greater than about 10 ppm.

5. The method of claim 4 wherein said second concentration of water is not greater than about 1 ppm.

6. The method of claim 1 wherein said anhydrous hydrogen fluoride produced from said contacting step is essentially free of moisture.

7. The method of claim 1 wherein said anhydrous hydrogen fluoride produced from said contacting step contains un-reacted carbonyl fluoride.

8. The method of claim 1 wherein a ratio of said first concentration of water to said second concentration is at least 2:1.

9. The method of claim 8 wherein said ratio is at least 1000:1.

10. The method of claim 9 wherein said ratio is at least 1,000,000:1.

11. The method of claim 1 wherein said contacting step is performed as a continuous process.

12. The method of claim 1 wherein said contacting step is performed as a batch process.

13. The method of claim 1 wherein said crude anhydrous hydrogen fluoride and said anhydrous hydrogen fluoride produced from said contacting step are in the liquid phase.

14. The method of claim 1 wherein said crude anhydrous hydrogen fluoride and said anhydrous hydrogen fluoride produced from said contacting step are in the gas phase.

15. The method of claim 1 further comprising the step of:
(c) removing from the anhydrous hydrogen fluoride produced from said contacting step at least a portion of a reaction by-product generated by said contacting step.

16. The method of claim 15 wherein said reaction by-product is carbon dioxide.

17. A method of preparing anhydrous hydrogen fluoride comprising the steps of:
(a) providing aqueous hydrogen fluoride; and
(b) contacting said aqueous hydrogen fluoride with carbonyl fluoride to produce anhydrous hydrogen fluoride.

18. An anhydrous composition comprising hydrogen fluoride and carbonyl fluoride.

19. The anhydrous composition of claim 18 having at least about 97 weight percent hydrogen fluoride and not more than about 1 weight percent of carbonyl fluoride.

20. The anhydrous composition of claim 19 wherein said composition is essentially free of moisture.
